(19) United States
(12) Patent Application Publication
(10) Pub. No.: US 2025/0081295 A1
(43) Pub. Date: Mar. 6, 2025

(54) Heating Structure for Electric Heating Floor

(71) Applicant: SHU-LIEN CHEN, Taichung City (TW)

(72) Inventor: SHU-LIEN CHEN, Taichung City (TW)

(21) Appl. No.: 18/810,522

(22) Filed: Aug. 21, 2024

(30) Foreign Application Priority Data
Aug. 29, 2023 (TW) 112132667

(51) Int. Cl. H05B 3/26

(52) U.S. Cl. CPC H05B 3/267; H05B 2203/017; H05B 2203/026

(57) ABSTRACT

The present invention provides a heating structure for an electric heating floor, includes a first base material layer, an electric heating film, an electrode, and a s second base material layer stacked in sequence from bottom to top. The adhesive is arranged on the first base material layer and the second base material layer, two ends of a first surface of the electric heating film are each arranged with the electrode, the first base material layer is adhered to a second surface of the electric heating film, and the second base material layer is adhered to the first surface of the electric heating film and the electrode. Each layer is adhered and fixed through a pressing process. The adhesive generates an adhesive force in the direction of penetrating the electrode and/or the electric heating film, so that the electric heating film is in close contact with the electrode.

### BACKGROUND OF THE PRESENT INVENTION

### Field of Invention

The present invention relates to electric floor heating systems, and more specifically to heating structures embedded in building floors.

### Description of Related Arts

As shown in FIG. 1, a schematic sectional view of a typical heating structure 1 of an electric heating floor. From bottom to top, it includes a first base material layer 2 (polyethylene terephthalate PET, polycarbonate PC, or polypropylene PP can be selected), an electric heating film 3 (positive temperature coefficient PTC, carbon fiber cloth, silver paste electric heating film, or indium tin oxide electric heating film can be selected), an electrode 4 (copper foil can be selected), and a second base material layer 5 (polyethylene terephthalate PET, polycarbonate PC, or polypropylene PP can be selected) are sequentially arranged. Each layer is bonded with adhesive 6 and fixed by pressing. The electrode 4 is connected to an external power source, and when energized, the electric heating film 3 generates heat.

The sequence of arrangement is roughly that the adhesive 6 is arranged on the upper surface of the first base material layer 2 and the lower surface of the second base material layer 5, the electrode 4 is arranged on the first surface of the electric heating film 3, the first base material layer 2 is bonded to the second surface of the electric heating film 3 with the adhesive 6, and the second base material layer 5 is bonded to the first surface of the electric heating film 3 and the electrode 4 with the adhesive 6. The thermal expansion rate and cold shrinkage rate of the electric heating film 3 and the electrode 4 are different, causing a slight gap to appear between the electric heating film 3 and the electrode 4, and the two are not fully in close contact. Therefore, a short circuit state similar to poor circuit contact is likely to occur, and even sparks may occur, posing safety concerns.

### SUMMARY OF THE PRESENT INVENTION

The technical features of the present invention to solve the above problems are:

A heating structure for an electric heating floor, wherein the heating structure includes a first base material layer, an electric heating film, an electrode, and a s second base material layer stacked in sequence from bottom to top, wherein the adhesive is arranged on the first base material layer and the second base material layer, two ends of a first surface of the electric heating film are each arranged with the electrode, the first base material layer is adhered to a second surface of the electric heating film, and the second base material layer is adhered to the first surface of the electric heating film and the electrode, wherein each layer is adhered and fixed through a pressing process, wherein the electrode is connected with an external power source, and when energized, the electric heating film generates heat, wherein the adhesive generates an adhesive force in the direction of penetrating the electrode and/or the electric heating film, so that the electric heating film is in close contact with the electrode.

Efficacy of the present invention:

As described in the prior art, because the thermal expansion rate and cold shrinkage rate of the electric heating film and the electrode are different, there is an external force between the two to separate them, resulting in a slight gap, so that a problem similar to the poor contact of the circuit occurs. However, through the above-mentioned present invention, the joint portion generates an adhesive force in a direction that penetrates either or both of the electrode and the electric heating film, the adhesive force can resist the external force that makes the electric heating film separate from the electrode, and can maintain the close contact between the electric heating film and the electrode in a normal manner, reduce or avoid the appearance of slight gap between them, reduce or avoid the short circuit state of poor contact between the two, and improve the use safety of this heating structure.

### BRIEF DESCRIPTION OF THE DRAWINGS

FIG. 1 is a sectional view of a prior art heating structure.

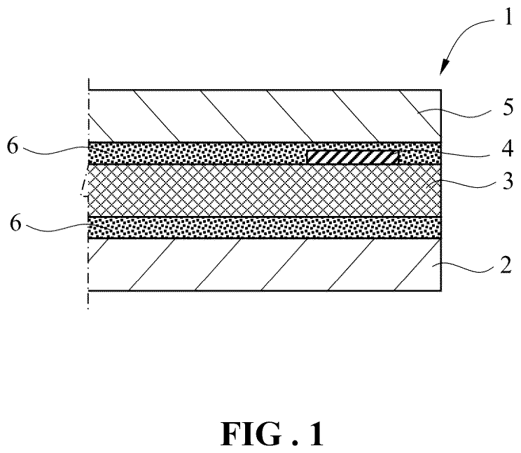

FIG. 2 is an exploded view of the heating structure of a first embodiment of the present invention.

FIG. 3 is a partially enlarged sectional exploded view of the heating structure of the first embodiment of the present invention.

FIG. 4 is a partially enlarged sectional combination view of the heating structure of the first embodiment of the present invention.

FIG. 5 is a partially enlarged sectional exploded view of the heating structure of a second embodiment of the present invention.

FIG. 6 is a partially enlarged sectional combination view of the heating structure of the second embodiment of the present invention.

FIG. 7 is a partially enlarged sectional exploded view of the heating structure of a third embodiment of the present invention.

FIG. 8 is a partially enlarged sectional combination view of the heating structure of the third embodiment of the present invention.

FIG. 9 is an exploded view of the heating structure of a fourth embodiment of the present invention.

FIG. 10 is a partially enlarged sectional combination view of the heating structure of the fourth embodiment of the present invention.

### DETAILED DESCRIPTION OF THE PREFERRED EMBODIMENT

In order to facilitate the explanation of the central concept expressed in the above-mentioned summary of the present invention, specific embodiments are hereby expressed. Various objects in the embodiments are drawn according to the proportions, sizes, deformations or displacements suitable for illustration, rather than according to the proportions of actual components. Directional terms such as upper and lower are used in the following description, which are expressed in accordance with the viewing direction and cannot be construed as limitations of the present invention.

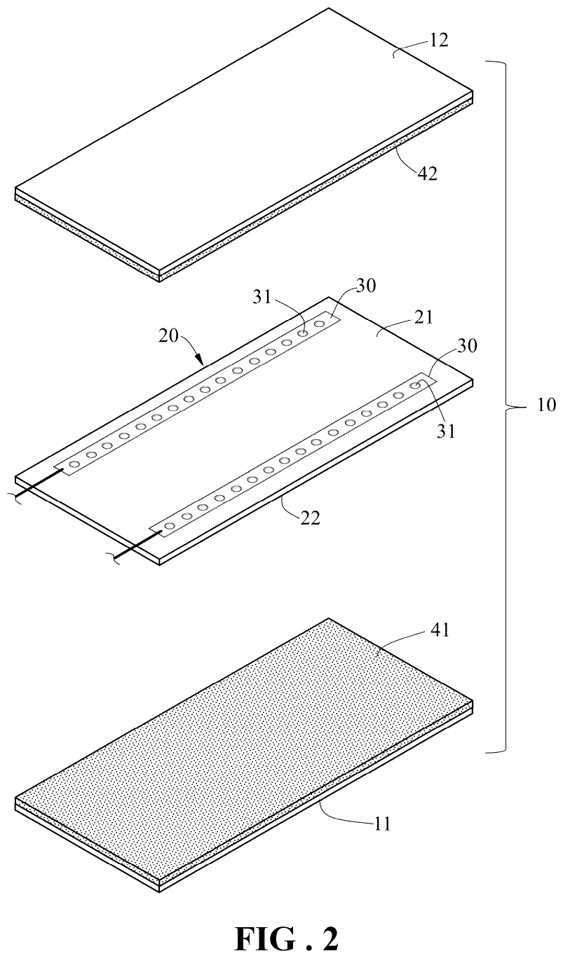

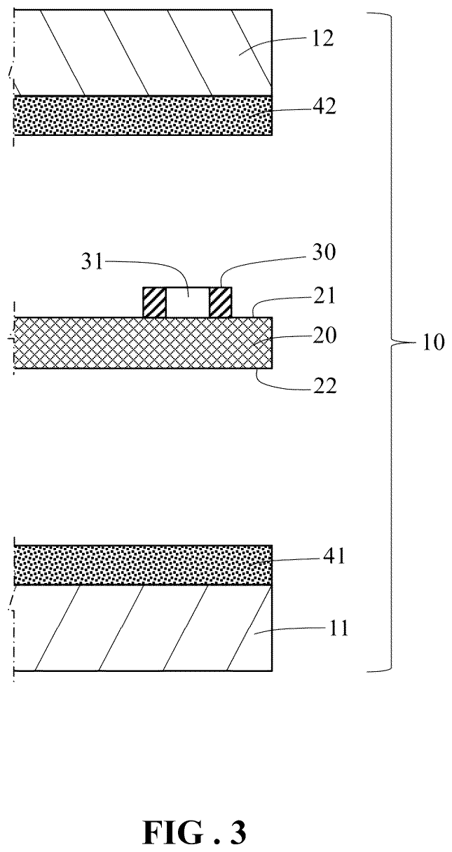

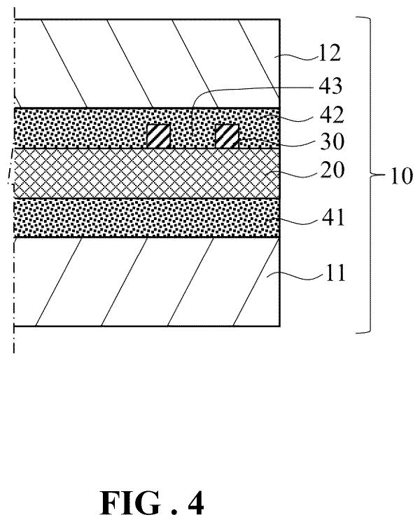

As shown in FIGS. 2 to 4, the heating structure 10 of the present invention includes a first base material layer 11, an electric heating film 20, an electrode 30, and a second base material layer 12 stacked in sequence from bottom to top. Each layer is bonded with an adhesive and fixed by pressing. The electrode 30 is connected with an external power source, and when energized, the electric heating film 20 generates heat.

The method of arrangement is roughly that a first adhesive 41 is arranged on an upper surface of the first base material layer 11, a second adhesive 42 is arranged on a lower surface of the second base material layer 12, two ends of a first surface 21 of the electric heating film 20 are arranged with the electrode 30, the first base material layer 11 is adhered to a second surface 22 of the electric heating film 20 with the first adhesive 41, and the second base material layer 12 is adhered to the first surface 21 of the electric heating film 20 and the electrode 30 with the second adhesive 42. After being pressed and fixed, adjacent films and layers are adhered and fixed to each other.

The materials of the first base material layer 11 and the second base material layer 12 include, but are not limited to, polyester plastic (PET).

The electrode 30 includes, but is not limited to, copper foil, aluminum foil, silver foil, or carbon conductive film. The width W of the electrode 30 is greater than 5 mm.

The electric heating film 20 includes, but is not limited to, a fiber cloth that can conduct electricity and generate heat.

The first adhesive 41 and the second adhesive 42 include, but are not limited to, thermoplastic resin.

As shown in FIGS. 2 to 4, the first embodiment:

The electrode 30 includes a plurality of holes 31 arranged thereon, and the holes 31 are circular or elongated.

During the pressing and fixing process of the heating structure 10, the second adhesive 42 melts and flows into the holes 31 of the electrode 30 and is bonded to the partial surface of the electric heating film 20 corresponding to the holes 31. After the second adhesive 42 solidifies, a joint portion 43 is formed in each of the holes 31. The joint portion 43 enables the second base material layer 12 to form an adhesive relationship with the electric heating film 20 and the inner wall of the holes 31. In other words, the joint portion 43 causes the second base material layer 12 and the electric heating film 20 to generate an adhesive force in the direction of penetrating the electrode 30. The adhesive force also forms a relative pulling force parallel to the axis of the hole 31 for the second base material layer 12 and the electric heating film 20. The relative pulling force causes the electric heating film 20 to closely contact the lower surface of the electrode 30, and the second base material layer 12 to closely contact the upper surface of the electrode 30.

As described in the prior art, because the thermal expansion rate and cold shrinkage rate of the electric heating film 20 and the electrode 30 are different, there is an external force between the two to separate them, resulting in a slight gap and a problem similar to poor circuit contact. However, through the present invention, the adhesive force can resist the external force that makes the electric heating film 20 separate from the electrode 30, and can maintain the close contact between the electric heating film 20 and the electrode 30 in a normal manner, reduce or avoid the appearance of slight gap between them, reduce or avoid the short circuit state of poor contact between the two, and improve the use safety of this heating structure 10.

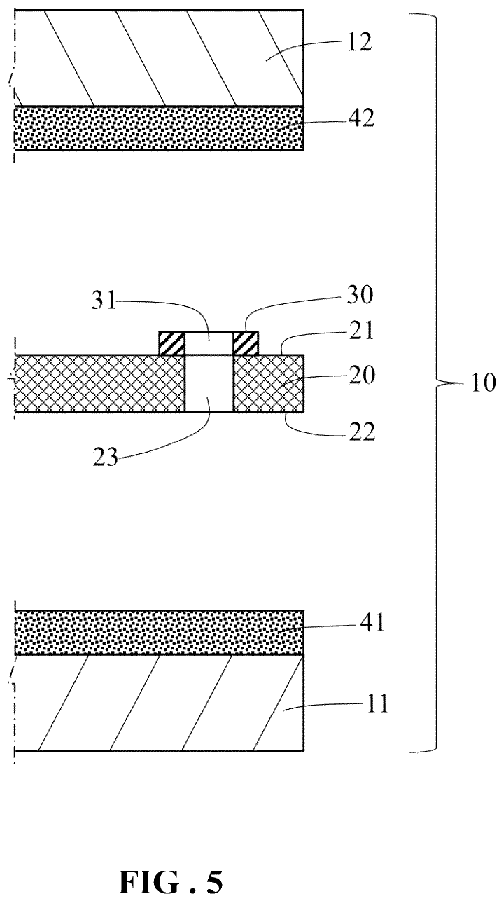

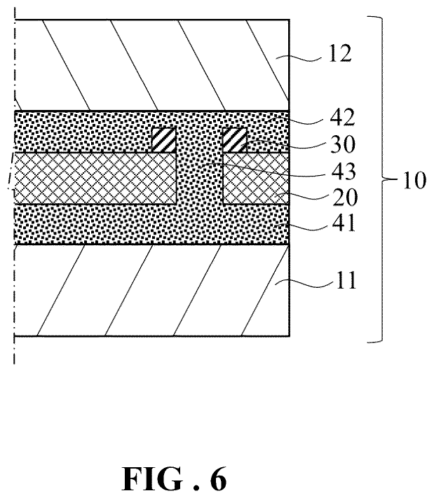

As shown in FIGS. 5 and 6, the second embodiment:

A plurality of holes 23 are arranged through the electrode 30 and the electric heating film 20 correspondingly, and the holes 23 are circular or elongated.

During the process of pressing and fixing the heating structure 10, the second adhesive 42 melts and flows into the holes 31 of the electrode 30. The first adhesive 41 melts and flows into the holes 23 of the electric heating film 20. The first adhesive 41 and the second adhesive 42 are cross-linked and solidified with each other in the holes 23 and 31 to form a joint portion 43. The joint portion 43 causes the first base material layer 11 and the second base material layer 12 to generate an adhesive force in the direction of penetrating the electric heating film 20 and the electrode 30. The adhesive force makes the first base material layer 11 and the second base material layer 12 form relative pressure on the electrode 30 and the electric heating film 20, so that the electrode 30 and the electric heating film 20 are in close contact, thereby resisting the external force that separates the electric heating film 20 from the electrode 30, reducing or avoiding the occurrence of slight gap between the two, reducing or avoiding the poor contact and short circuit state between the two, and improving the use safety of the heating structure 10.

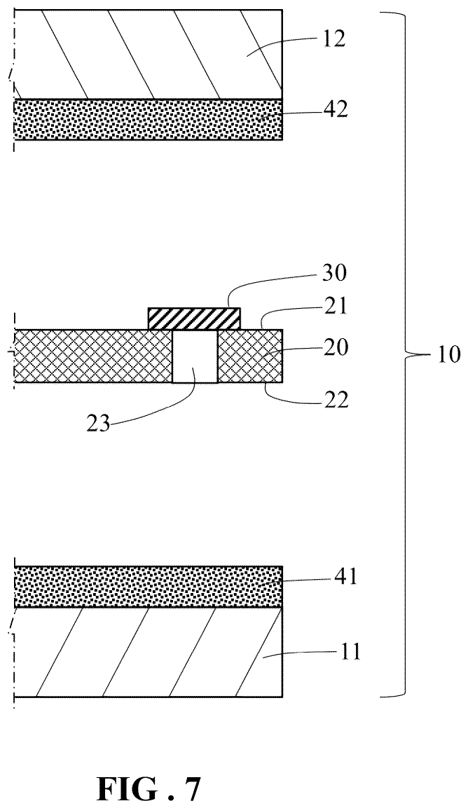

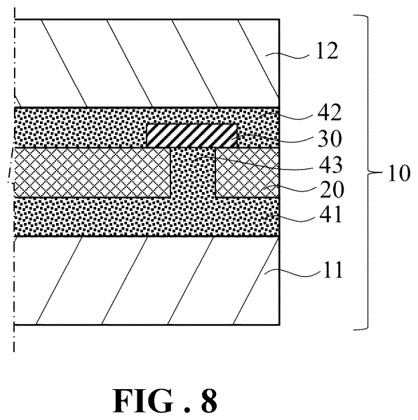

As shown in FIGS. 7 and 8, the third embodiment:

A plurality of holes 23 are arranged in the portion of the electric heating film 20 corresponding to the electrode 30, and the holes 23 are circular or elongated.

During the process of pressing and fixing the heating structure 10, the first adhesive 41 melts and flows into the holes 23 of the electric heating film 20 and adheres to the partial surface of the electrode 30 corresponding to the holes 23. After the first adhesive 41 solidifies, a joint portion 43 is formed in the holes 23. The joint portion 43 causes the first base material layer 11 and the electrode 30 to generate an adhesive force in the direction of penetrating the electric heating film 20. The adhesive force also forms a pulling force parallel to the axis of the hole 23 for the first base material layer 11 and the electrode 30, so that the electrode 30 is in close contact with the electric heating film 20. The adhesive force can resist the above-mentioned external force that makes the electric heating film 20 separate from the electrode 30, and can maintain the close contact between the electric heating film 20 and the electrode 30 in a normal manner, reduce or avoid the appearance of slight gap between them, reduce or avoid the short circuit state of poor contact between the two, and improve the use safety of this heating structure 10.

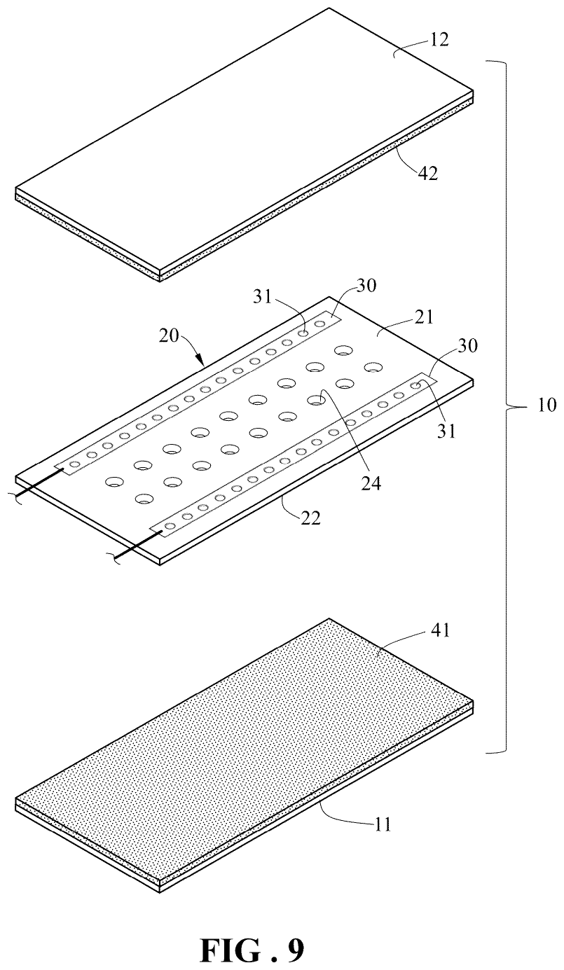

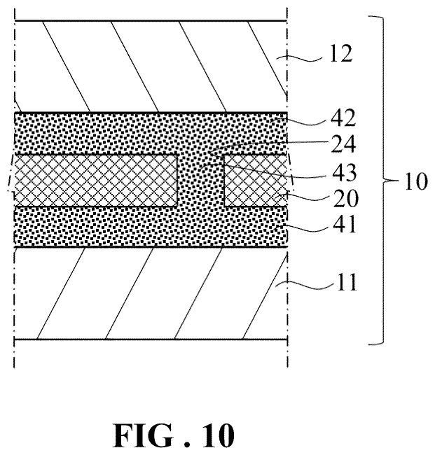

As shown in FIGS. 9 and 10, the fourth embodiment:

The electric heating film 20 has a plurality of holes 24 arranged through the first surface 21 and the second surface 22 in the portion where the electrode 30 is not provided (that is, in the portion of the electric heating film 20 other than the electrode 30).

During the hot pressing and fixing process of the heating structure 10, the first adhesive 41 and the second adhesive 42 melt and flow into the holes 24 and are cross-linked and solidified to form the joint portion 43. The joint portion 43 causes the first base material layer 11 and the second base material layer 12 to generate an adhesive force in the direction of penetrating the electric heating film 20.

What is claimed is:

1. A heating structure for an electric heating floor, wherein the heating structure comprises a first base material layer, an electric heating film, an electrode, and a s second base material layer stacked in sequence from bottom to top, wherein a first adhesive is arranged on an upper surface of the first base material layer, a second adhesive is arranged on a lower surface of the second base material layer, two ends of a first surface of the electric heating film are each arranged with the electrode, the first base material layer is adhered to a second surface of the electric heating film with the first adhesive, and the second base material layer is adhered to the first surface of the electric heating film and the electrode with the second adhesive, wherein adhering and fixing through a hot pressing process, wherein the electrode is connected with an external power source, and when energized, the electric heating film generates heat, wherein
a plurality of holes are arranged through the electrode and the electric heating film correspondingly, wherein
in the hot pressing process, the second adhesive melts and flows into the holes of the electrode, the first adhesive melts and flows into the holes of the electric heating film, and the first adhesive and the second adhesive are cross-linked and solidified with each other in the holes of the electrode and the holes of the electric heating film to form a joint portion, wherein the joint portion causes the first base material layer and the second base material layer to generate an adhesive force in a direction penetrating the electric heating film and the electrode, so that the electrode and the electric heating film are in close contact.

2. A heating structure for an electric heating floor, wherein the heating structure comprises a first base material layer, an electric heating film, an electrode, and a s second base material layer stacked in sequence from bottom to top, wherein a first adhesive is arranged on an upper surface of the first base material layer, a second adhesive is arranged on a lower surface of the second base material layer, two ends of a first surface of the electric heating film are each arranged with the electrode, the first base material layer is adhered to a second surface of the electric heating film with the first adhesive, and the second base material layer is adhered to the first surface of the electric heating film and the electrode with the second adhesive, wherein adhering and fixing through a hot pressing process, wherein the electrode is connected with an external power source, and when energized, the electric heating film generates heat, wherein
a plurality of holes are arranged in the portion of the electric heating film corresponding to the electrode, wherein
in the hot pressing process, the first adhesive melts and flows into the holes of the electric heating film and adheres to a partial surface of the electrode corresponding to the holes, wherein after the first adhesive solidifies, a joint portion is formed in the holes, and the joint portion causes the first base material layer and the electrode to generate an adhesive force in a direction penetrating the electric heating film, so that the electrode is in close contact with the electric heating film.

3. A heating structure for an electric heating floor, wherein the heating structure comprises a first base material layer, an electric heating film, an electrode, and a s second base material layer stacked in sequence from bottom to top, wherein a first adhesive is arranged on an upper surface of the first base material layer, a second adhesive is arranged on a lower surface of the second base material layer, two ends of a first surface of the electric heating film are each arranged with the electrode, the first base material layer is adhered to a second surface of the electric heating film with the first adhesive, and the second base material layer is adhered to the first surface of the electric heating film and the electrode with the second adhesive, wherein adhering and fixing through a hot pressing process, wherein the electrode is connected with an external power source, and when energized, the electric heating film generates heat, wherein
the electric heating film has a plurality of holes arranged through the first surface and the second surface in the portion other than the electrode, wherein
in the hot pressing process, the first adhesive and the second adhesive melt and flow into the holes, and are cross-linked and solidified to form a joint portion, wherein
the joint portion causes the first base material layer and the second base material layer to generate an adhesive force in a direction penetrating the electric heating film.
